(19) United States
(12) Patent Application Publication
(10) Pub. No.: US 2015/0340177 A1
(43) Pub. Date: Nov. 26, 2015

(54) KEYPAD SHIELD FOR ELECTRONIC TERMINAL KEYPAD AND CORRESPONDING ELECTRONIC TERMINAL

(71) Applicant: Ingenico Group, Paris (FR)

(72) Inventors: Fabien Demange, Saint-Peray (FR); David Naccache, Paris (FR); Pierre Martinez, L'Etang La Ville (FR)

(21) Appl. No.: 14/721,773

(22) Filed: May 26, 2015

(30) Foreign Application Priority Data
May 23, 2014 (FR) 1454643

(51) Int. Cl. H01H 13/86; H01H 13/04

(52) U.S. Cl. CPC H01H 13/86; H01H 13/04; H01H 2223/03; H01H 2223/044

(57) ABSTRACT

A keypad shield for a keypad of an electronic payment terminal includes at least one key, called an externalized key. The externalized key enables activation of at least one corresponding key of the keypad.

### 1 CROSS-REFERENCE TO RELATED APPLICATIONS

This Application claims priority from and the benefit of French Patent Application No. FR 14 54643, filed May 23, 2014, the content of which is incorporated herein by reference in its entirety.

### 2 FIELD OF THE DISCLOSURE

The present disclosure relates to the field of electronic payment terminals, and more particularly to electronic payment terminals having a device known as a keypad shield or code-cache device.

Such a keypad shield enables the electronic payment terminal to respond to the requirements of securing confidential code entry by a user according to prevailing international standards, by concealing/masking the keys of the keypad from a person who is not situated in front of the keypad. This area of the keypad masked by the keypad shield is called an area of privacy.

### 3 PRIOR-ART SOLUTIONS

There are numerous solutions for making keypad shields, aimed at making the keypad accessible, with optimal ergonomy, to the user entering his confidential code and, at the same time, making it totally or partially masked from any other person in the vicinity of the electronic payment terminal (including the merchant who owns the electronic payment terminal).

Thus, a first technique provides for a device forming a sort of vertical screen, of variable height, on one or more sides of the keypad. Such a solution effectively secures the entry of a confidential code by a user but has the drawback of increasing the size of the electronic payment terminal, especially in height.

Certain solutions enable these drawbacks to be overcome by making such a keypad shield detachable. Thus, when the merchant wishes to put away or store an electronic payment terminal (for example outside his opening times), he can remove the keypad shield and thus gain storage space. However, the fact remains that the keypad shield must also be stored independently of the electronic payment terminal with the possible risk of misplacing it or damaging it when it is not fixedly joined to the electronic payment terminal. Another drawback lies in the fragility of the detachable keypad shield, especially at the fastening points of the electronic payment terminal.

Other approaches therefore provide for a pivoting keypad shield, i.e. one that is always fixed to the electronic payment terminal but can be easily retracted, if necessary, to gain space when storing the electronic payment terminal.

However, there remains one drawback in all the prior-art techniques when the electronic payment terminal is presented before a user, for example so that he can enter his confidential code and when the merchant needs to press one of the keys of the keypad (for example a function key). In this case, the merchant has to either take back the electronic payment terminal to have it before him or remove the keypad shield or pivot it in order to access the desired key. This leads to loss of time and additional handling operations and makes the task of entering the confidential code more irksome.

There is therefore a need for a solution to provide a technique for masking the keys of a keypad of an electronic payment terminal thus ensuring compliance with security requirements for payment terminals while at the same time offering optimal ergonomy to the different users of the electronic payment terminal, for example the customer and the merchant.

There is also a need for an optimal solution in terms of cost, in a competitive environment where the cost of a terminal is a major factor for manufacturers.

### 4 SUMMARY

An exemplary embodiment of the present disclosure relates to a keypad shield for a keypad of an electronic payment terminal, the keypad shield comprising at least one key, called an externalized or raised key, enabling the activation of at least one corresponding key of the keypad.

Thus, the disclosure in one or more different particular embodiments proposes a novel and inventive keypad shield or code-cache solution for a keypad of an electronic payment terminal to optimize the ergonomic comfort of such an electronic terminal while offering the possibility of activating one (or more) keys of the keypad (situated in the area of privacy created by the keypad shield) via one or more keys externalized on to the keypad shield, and therefore visible to all.

Indeed, when a person not situated before the keypad (for example a merchant) has to access a key situated in the area of privacy created by the keypad shield at a time when the electronic terminal is oriented so as to be facing the user (for example a customer entering his confidential code on an electronic payment terminal during a transaction), it is preferably that this key should be integrated into the keypad shield and therefore not masked by this device so that the person can activate it without having to handle the electronic terminal (for example without having to turn it towards him). This can be the case with a merchant wishing to help a user of the keypad, for example when entering his confidential code, by pressing the “Correct” or “Cancel” key himself.

According to another example, it is more ergonomical for a merchant using the electronic payment terminal to have the use of one or more externalized keys, other than the alphanumeric keys, which are thus more accessible to him even when the electronic payment terminal is oriented so as to be facing the customer

For example, the externalized key comprises:
a visible upper face to be used to activate the corresponding key of the keypad, by pressure on the upper face and
a lower face having at least one rod extending towards the keypad so that when a pressure is applied to the externalized key, the rod comes into contact with the corresponding key of the keypad.

Thus, according to this embodiment, the externalized key integrated into the keypad shield activates the corresponding key of the keypad by means of a rod extending from its lower face to the keypad, this rod coming into contact with the key of the keypad when pressure is applied to the externalized key. The contact between the rod of the externalized key and the key of the keypad acts as a classic type of “pressure” on this keypad in ensuring electrical contact at the electronic card situated beneath the keypad.

The mechanical externalizing/shifting of the key is thus provided by the rod.

According to one particular aspect of the disclosure, the externalized key corresponds to a function key of the keypad.

Thus, according to this embodiment, and if we consider a classic keypad of an electronic payment terminal comprising at least thirteen keys, of which ten keys are alphanumeric and at least three are function keys (confirm, cancel, correct, etc.), the externalized key or keys correspond to a function key, for example a function key used mainly by the merchant who owns the electronic payment terminal or else a function key used by a customer entering his confidential code.

For example, this externalized key corresponds to a key denoted as “i” or “F”, or “Home” situated classically at the top right-hand corner of an electronic payment terminal keypad.

Thus, this embodiment not only enables this function keypad to be made accessible to the merchant, even when the electronic payment terminal is oriented so as to be facing the customer (and when the key is situated in the area of privacy created by the keypad shield) thus facilitating the use of the electronic payment terminal but also prevents a false activation of this function key because of a handling mistake by the customer when he enters his confidential code.

Indeed, through an exemplary embodiment, this function key is no longer accessible on the keypad in itself when the keypad shield is present. There is therefore a deliberate and specific action needed to activate this function key through the externalized key on the keypad shield.

Thus, according to one or more different embodiments, all the keys of a keypad that are not alphanumeric keys can be externalized.

According to one particular characteristic of the disclosure, the rod has a length appreciably smaller than the distance between the lower face of the externalized key and the corresponding key of the keypad.

Thus, according to this embodiment, the length of the rod is defined so that the rod does not come into contact with the key of the keypad unless the pressure is applied to the externalized key leading to an appreciably vertical translation (of about 0.5 mm) of the rod towards the keypad.

In the resting position, i.e. when no pressure is applied to the externalized key, the lower part of the rod remains above the key corresponding to the keypad without activating it.

For example, the length of said rod is 20 millimeters.

Thus, according to this embodiment, a rod length of 20 millimeters gives optimal functioning of the externalized key, firstly by ensuring activation of the corresponding key of the keypad when pressure is applied to the externalized key and secondly by preventing false pressure when the externalized key is simply brushed over inadvertently.

According to one particular aspect of the disclosure, the keypad shield comprises an elastic return of the rod.

Thus, the elastic return of the rod, added to the return created by the key of the keypad, provides maximum security for the working and the tactile effect of the externalized key.

The elastic return is for example a part of the keypad shield taking the form of a bi-material elastomer element. For example, the elastic return comprises a lower part made of rigid plastic so that they are properly held on the terminal and a flexible upper part made of elastomer to ensure more comfortable use when the finger comes into contact with the keypad shield.

According to one particular aspect of the disclosure, the rod is hollow throughout the length of its longitudinal axis as well as its two ends. In this way, a channel is created in the rod, for example at its mid-point, throughout its length so as to let the light pass through and especially the light for backlighting the corresponding key situated on the keypad.

Thus, the externalized key can also be lit via this light channel in the rod.

This channel can consist for example of a transparent elastic part letting light pass through (somewhat on the principle of an optic fiber). The means for backlighting the externalized key are classic known means for lighting up a key by a light source situated beneath the key.

According to one embodiment of the disclosure, the keypad shield is retractable. This feature enables easier use when the data to be entered on the keypad is not confidential, for example when a merchant is configuring an electronic payment terminal. It also provides a gain in space when the electronic terminal is put away.

Another aspect of the disclosure relates to an electronic terminal comprising a keypad shield as described here above according to one or more different embodiments of the disclosure.

In particular, such a terminal is an electronic payment terminal.

### 5 LIST OF FIGURES

Other features and advantages of the disclosure shall appear more clearly from the following description of a particular embodiment given by way of a simple illustratory and non-exhaustive example and from the appended drawings, of which:

FIGS. 1a to 1c present three views of a keypad shield according to one embodiment of the disclosure;

FIG. 2 presents a view of the rod of an externalized key of the keypad shield according to one embodiment of the disclosure;

FIG. 3 presents a view of a part of an electronic terminal without a keypad shield according to the prior art;

FIG. 4 presents two views of a part of an electronic payment terminal respectively without and with a keypad shield according to one particular embodiment of the disclosure.

### 6 DETAILED DESCRIPTION OF ILLUSTRATIVE EMBODIMENTS

### 6.1 Exemplary General Principle

An exemplary principle of the disclosure relates to providing a technique for complying with security rules related to the entry of confidential data on a keypad of an electronic terminal via a keypad shield while at the same time making at least one key on this keypad accessible so as to optimize the ergonomy of such an electronic terminal.

One or more embodiments of the disclosure can be applied more particularly to electronic payment terminals but it goes without saying that the disclosure is not limited to this type of terminal and can be applied to any electronic terminal that has to deal with proximate or similar problems and issues. 6.2 Description of one embodiment

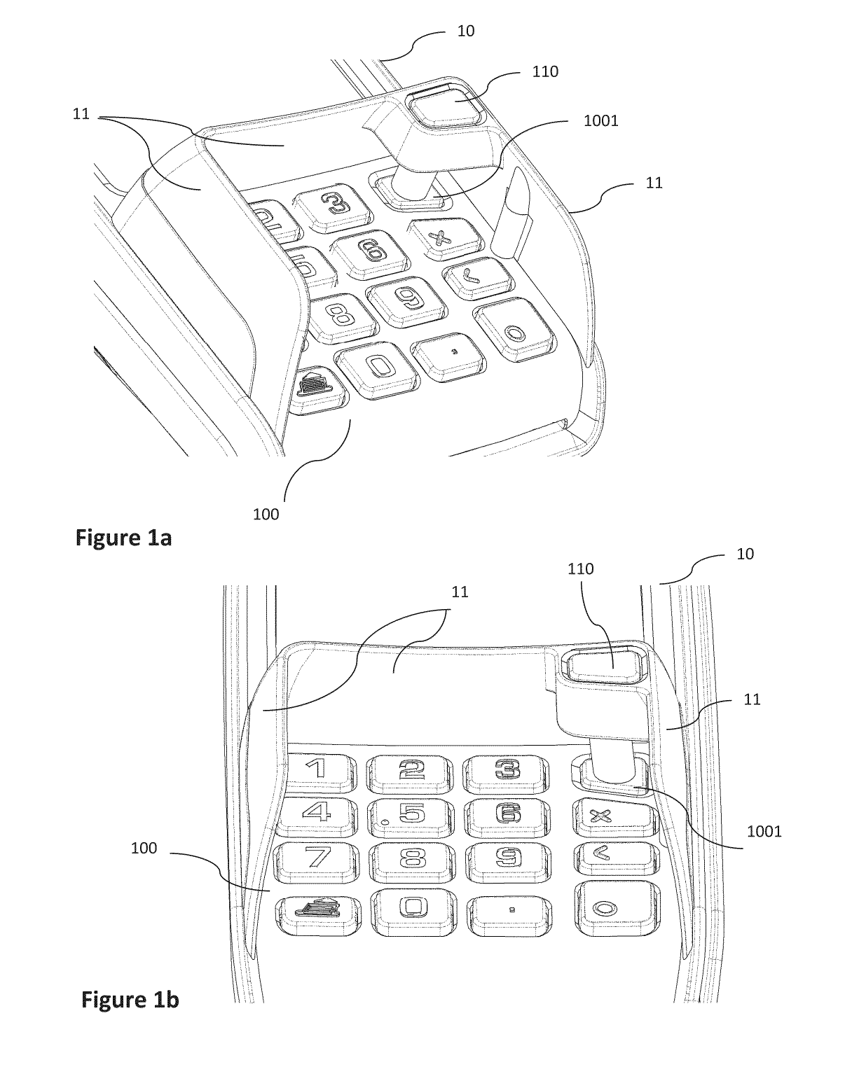

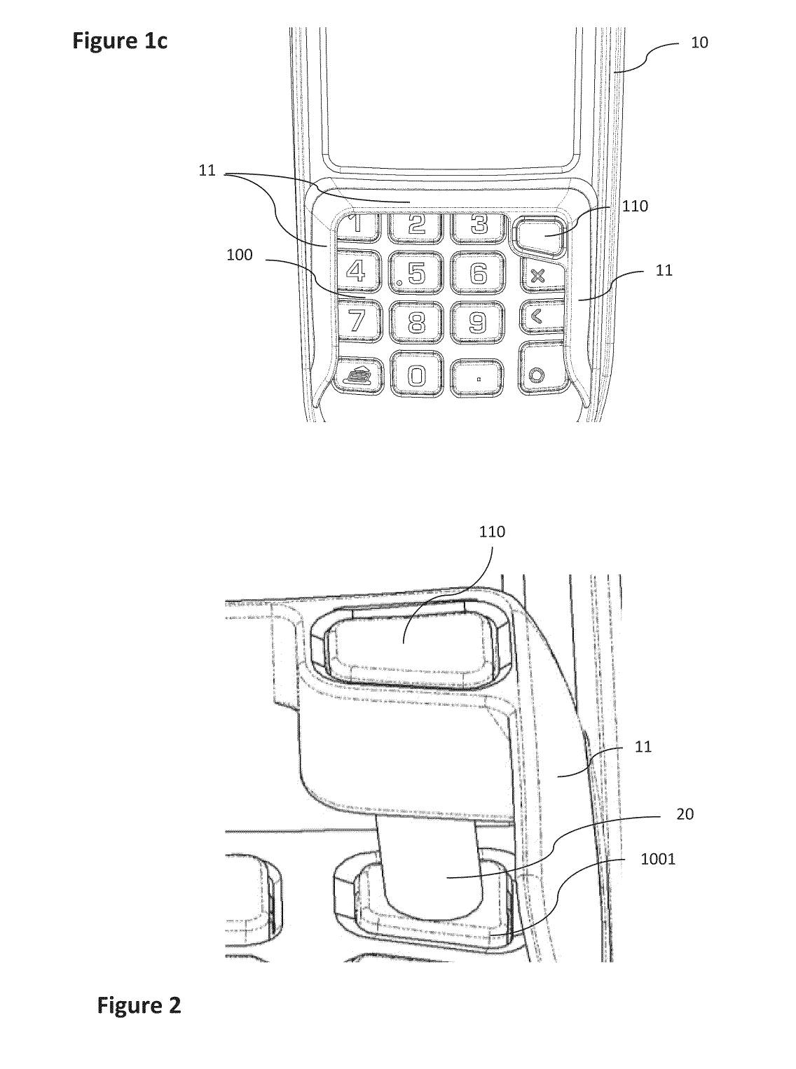

Referring now to FIGS. 1a to 1c and 2, a description is provided of a particular embodiment of the disclosure.

Figure la presents a side view of an electronic payment terminal 10 intended especially for the entry of sensitive data such as a confidential code during a transaction. The terminal has a keypad 100, for example in the form of a numerical pad comprising sixteen keys, including alphanumeric keys and function keys (confirm, cancel, correct, etc.).

The electronic payment pad 10 also has a keypad shield 11 formed by three walls and used to mask the keys of the keypad 100 from a person who is not facing the keypad 100.

According to this embodiment of the disclosure, the keypad shield comprises an externalized key 110 to activate the corresponding key 1001 of the keypad 100 of the electronic payment terminal 10.

FIG. 1b presents a front view of the electronic payment terminal 10 of FIG. 1a and FIG. 1c presents a top view of this same electronic payment terminal 10 (the corresponding key 1001 of the keypad 100 cannot be seen because it is masked by the externalized key 110 of the keypad shield 11).

Thus, according to this embodiment of the disclosure, when a user who is not situated before the keypad wishes to activate the key 1001 of the keypad situated in the area of privacy created by the keypad shield, he can press the externalized key 110 on the keypad shield 10 whereas, with a prior-art electronic payment terminal equipped with a keypad shield, the user would have to orient the electronic payment terminal so that it faces him in order to be able to access the key 1001 of the keypad situated in the area of privacy created by the keypad shield.

Thus, one or more different embodiments of the disclosure make it easier to access a key previously masked by a keypad shield according to the prior-art techniques.

FIG. 2 more particularly illustrates the working of the externalized key and the mechanical implementation of the externalizing/shifting of keys.

Thus, the keypad shield 11 presents an externalized key 110, of which the upper face is intended for activating this key 110 by pressure and the lower face (not visible) presents a rod 20 extending towards the keypad 100 and more particularly the corresponding key 1001.

To enable efficient working of the externalized key, and especially efficient activation of the corresponding key of the keypad when pressure is applied on the externalized key, the length of the rod has to be defined precisely, as a function especially of the height of the keypad shield (since the rod is part of the externalized key integrated with the keypad shield) and also as a function of the sensitivity of translation of the externalized key when pressure is applied.

Indeed, it is necessary not only to ensure optimal activation of the corresponding key of the keypad so that each pressure on the externalized key effectively activates the corresponding key of the keypad but also, at the same time, prevent to the utmost any false pressure caused by a simple brushing against the externalized key, for example when the electronic payment terminal is being handled.

Thus, the length of the rod must be defined so that:
the rod is not in contact with the corresponding key of the keypad, in the idle position, i.e. when no pressure is applied to the externalized key, and
the lower end of the rod comes sufficiently into contact with the key of the keypad to activate it, i.e. to apply sufficient pressure thereto to ensure electrical contact at the electronic board situated beneath the keypad, when pressure is applied to the externalized key.

For example, such pressure on the externalized key leads to a substantially vertical translation of this externalized key and therefore of the rod by about 0.5 mm. The length of the rod must therefore be defined so that this translation of about 0.5 mm puts it into contact with the corresponding key of the keypad to activate this keypad.

For example, the rod has a length of about 20 mm for a keypad shield of classic height.

In addition, the rod must have a width sufficient to exert uniform pressure on the corresponding key of the keypad so as to activate it in an optimal way.

Finally, the position at which the rod must exert pressure on the key of the keypad must also be defined optimally. For example the pressure will be exerted in the middle of the key of the keypad.

The disclosure is naturally not limited to this particular embodiment and the rod 20 can advantageously be replaced by any other means (an element having appreciably the same shape as the keys, with several “lugs”, etc.) to activate the corresponding key of the keypad when pressure is made on the externalized key.

According to another aspect of the disclosure, when the keys of the keypad of the electronic payment terminal are illuminated, for example by a light source coming from beneath the keys, it is possible to illuminate also the externalized key or keys. To this end, it is planned that the rod described here above will be hollowed out along its longitudinal axis and therefore have a sort of longitudinal channel, throughout its length, also leading into its two ends, in order to let light pass through inside the rod. In this way, via this channel, the illumination of the key of the keypad can reach on to the externalized key.

This channel can for example be formed by a transparent mechanical part or any other technique (fiber optics, etc.) that lets light pass through.

### 6.3 Example of an Application

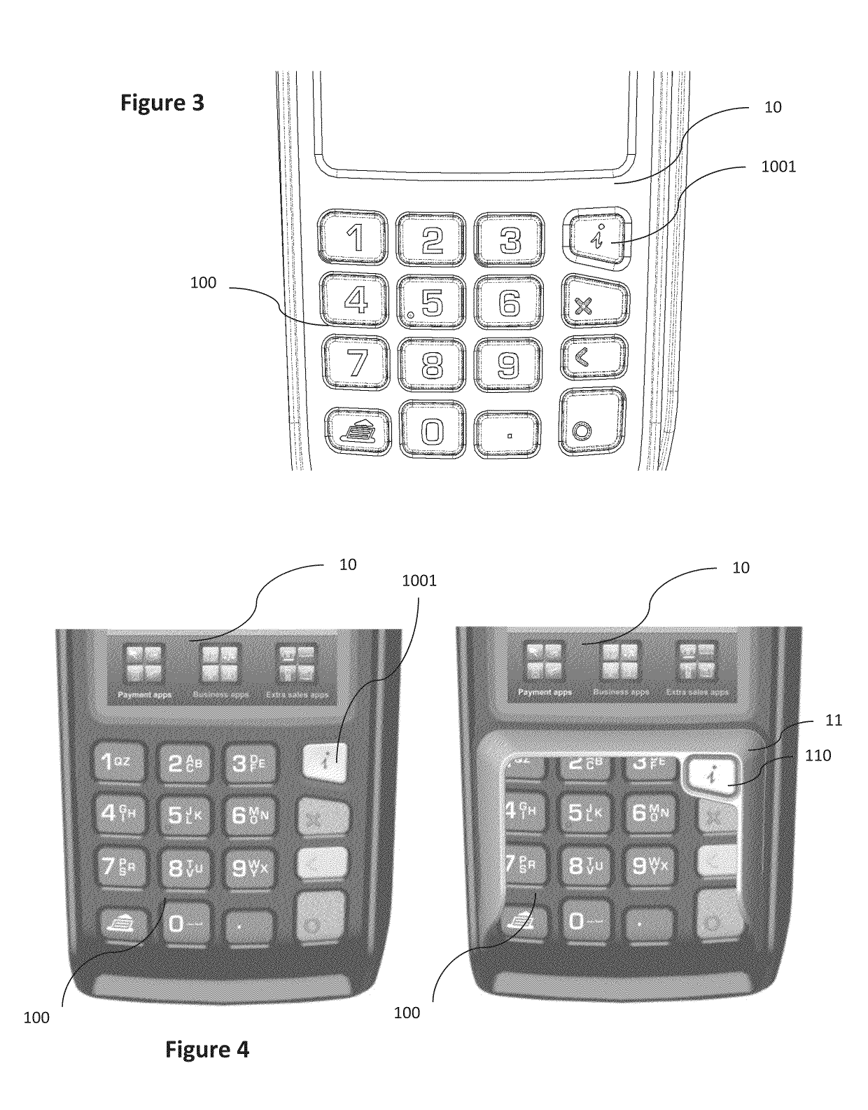

FIGS. 3 and 4 illustrate an example of an application of the disclosure according to one of its embodiments in which the function key of an electronic payment terminal 10 is externalized on to the keypad shield 11 thus enabling this function key “i” to be activated by pressure on the externalized key of the keypad shield, including when the electronic payment terminal is not oriented towards the user wishing to activate this function key.

For example, this function key corresponds to the key denoted “i” or “F” or “Home” classically situated at the top right-hand on a keypad of an electronic payment terminal.

Thus, it is preferably for this function key to be easily accessible by the merchant even when the electronic payment terminal provided with a keypad shield is not oriented so as to be facing him, for example because it is being used by a customer to enter his confidential code during a transaction.

And even if the merchant uses this key when the electronic payment terminal is oriented towards him, it is more ergonomical for this key to be more accessible and therefore externalized on to the keypad shield. Indeed, this key is used by him for example to display a menu on the touch screen of the electronic payment terminal and he then browses directly on the touch screen without using the keys of the keypad. Thus, the only key of the keypad that he needs is clearly highlighted above the keypad for better ergonomy.

This function key can for example be programmed by the merchant to fulfill a particular function.

According to one or more different examples of application of the disclosure, all the non-alphanumeric keys of a keypad can thus be externalized, for example a key used for the paper feed in the printer to edit a transaction record. The “.” and “*” keys used chiefly by the merchant can also be externalized to facilitate the use of the electronic payment terminal for this merchant.

FIG. 3 and the left-hand part of FIG. 4 present a top view of a part of an electronic terminal 10 without a keypad shield where the corresponding key 1001 of the keypad 100 is visible and accessible in the same way as the other keys of the keypad.

The right-hand part of FIG. 4 for its part has the same top view of the same part of the electronic terminal comprising a keypad shield 11 with an externalized key 110 to activate the key 1001 (not shown) situated in the area of privacy created by the keypad shield 11.

In these FIGS. 3 and 4, it is seen that the icon (in this case “1”) representing the function of the key 1001 is also present on the externalized key 110 of the keypad shield 11, making it easier for the user to locate the key.

Thus, one or more different embodiments of the disclosure makes a key of a keypad accessible via a key externalized on to the keypad shield so that a user can activate this key of the keypad, even when the electronic terminal is not facing the user and when the keypad is therefore masked by the keypad shield.

In addition, one or more different embodiments of the disclosure limit risks of false activation of this key of the keypad, for example through this key being brushed against when data is entered on the keypad. Thus, for certain function keys, such as for example the cancel key for cancelling previous entries, it is preferable to externalize their activation on to the keypad shield, preventing untoward entry via the keypad.

Although the present disclosure has been described with reference to one or more examples, workers skilled in the art will recognize that changes may be made in form and detail without departing from the scope of the disclosure and/or the appended claims.

1. A keypad shield for a keypad of an electronic payment terminal, wherein the keypad shield comprises:
at least one key, called an externalized key, enabling activation of at least one corresponding key of said keypad.

2. The keypad shield according to claim 1, wherein:
said externalized key comprises a visible upper face for activating said corresponding key of said keypad by pressure on said upper face, and a lower face having at least one rod extending towards said keypad;
said rod is positioned to come into contact with said corresponding key of said keypad when a pressure is applied to said externalized key.

3. The keypad shield according to claim 1, wherein said externalized key corresponds to a function key of said keypad.

4. The keypad shield according to claim 2, wherein said rod has a length appreciably smaller than a distance between said lower face of said externalized key and said corresponding key of the keypad.

5. The keypad shield according to claim 4, wherein said length of said rod is 20 millimeters.

6. The keypad shield according to claim 2, wherein said rod has an elastic return.

7. The keypad shield according to claim 2, wherein said rod is hollow throughout the length of its longitudinal axis as well as its two ends.

8. An electronic terminal comprising:
a keypad; and
a keypad shield for the keypad, wherein the keypad shield comprises at least one key, called an externalized key, enabling activation of at least one corresponding key of said keypad.

9. The electronic terminal according to claim 8, wherein said terminal is an electronic payment terminal.
